(19) United States
(12) Patent Application Publication
(10) Pub. No.: US 2016/0116102 A1
(43) Pub. Date: Apr. 28, 2016

(54) Connecting Systems for Adjacent Ends of Insulation Tubing

(71) Applicant: Aeroflex USA, Inc., Sweetwater, TN (US)

(72) Inventors: Darrell Pell, Rock Hill, SC (US); Brad Stevenson, Lenior City, TN (US); Greg Ertel, Clinton, TN (US)

(21) Appl. No.: 14/984,533

(22) Filed: Dec. 30, 2015

Related U.S. Application Data
(63) Continuation-in-part of application No. 13/774,497, filed on Feb. 22, 2013.

(51) Int. Cl. F16L 59/14

(52) U.S. Cl. CPC F16L 59/14

(57) ABSTRACT

A connector assembly for joining adjacent ends of insulation tubing, comprising a layer of pressure sensitive transfer adhesive material, said layer of pressure sensitive transfer adhesive material capable of bonding to insulation tubing, whereby when said layer of pressure sensitive transfer adhesive material is positioned between a first section of insulation tubing and a second section of insulation tubing, said layer of pressure sensitive transfer adhesive material bonds to both the first section of insulation tubing and the second section of insulation tubing; and a disposable release liner member adapted to hold said layer of pressure sensitive transfer adhesive material prior to positioning said layer of pressure sensitive transfer adhesive material between the first section of insulation tubing and the second section of insulation tubing.

### CROSS-REFERENCE TO RELATED APPLICATIONS

This application is a continuation-in-part of U.S. patent application Ser. No. 13/774,497, filed Feb. 22, 2013, the entire content of which is incorporated herein by reference.

### STATEMENT REGARDING FEDERALLY SPONSORED RESEARCH OR DEVELOPMENT

Not Applicable

### BACKGROUND OF THE INVENTION

1. Field of Invention

The present invention relates generally to systems and methods for joining adjacent ends of sections of insulation tubing.

2. Description of the Related Art

Insulation for pipes is known in the art. Insulation tubing is used for pipes and fittings that convey steam, hot materials, condensate, lubricants, cryogenic fluids and cold materials typically used in heating and air conditioning, power facilities, food processing facilities and petrochemical facilities. Thus, insulation tubing is employed in a wide array of industrial applications, such as boilers and petrochemical plants, and for a variety of purposes, including, for example, condensation control and energy conservation (e.g., minimizing thermal leakage).

Insulation tubing generally must be applied in sections. A problem arises of how to ensure a stable connection between two adjacent sections of insulation tubing.

U.S. Pat. No. 6,902,784, issued to Princell et al., discloses a pressure sensitive adhesive insulation structure for joining two adjacent insulation structures. The pressure sensitive insulation comprises a carrier having a first side and second side. A pressure sensitive adhesive is in communication with the first side and in communication with the second side for adhering an insulation structure, such as those used to insulate piping. When used for joining two adjacent insulation structures, the carrier remains in place between the adjacent insulation structures.

### BRIEF SUMMARY OF THE INVENTION

Example embodiments of the present general inventive concept can be achieved by providing a connector assembly for joining adjacent ends of insulation tubing, including a layer of pressure sensitive transfer adhesive material, said layer of pressure sensitive transfer adhesive material capable of bonding to insulation tubing, whereby when said layer of pressure sensitive transfer adhesive material is positioned between a first section of insulation tubing and a second section of insulation tubing, said layer of pressure sensitive transfer adhesive material bonds to both the first section of insulation tubing and the second section of insulation tubing; and a disposable release liner member adapted to hold said layer of pressure sensitive transfer adhesive material prior to positioning said layer of pressure sensitive transfer adhesive material between the first section of insulation tubing and the second section of insulation tubing, said disposable release liner member to be separated from said layer of pressure sensitive transfer adhesive material after said layer of pressure sensitive transfer adhesive material bonds to the first section of insulation tubing and before said layer of pressure sensitive transfer adhesive material bonds to the second section of insulation tubing.

Generally, the layer of pressure sensitive transfer adhesive material includes a pressure sensitive transfer adhesive material fabricated from a pressure-sensitive polymer.

In some example embodiments, the layer of pressure sensitive transfer adhesive material includes a scrim to reinforce the layer of pressure sensitive transfer adhesive material.

In some example embodiments, the layer of pressure sensitive transfer adhesive material includes an acrylic-based pressure sensitive transfer adhesive material.

In some example embodiments, the layer of pressure sensitive transfer adhesive material includes a rubber-based pressure sensitive transfer adhesive material.

Example embodiments of the present general inventive concept can also be achieved by providing a method of fabricating stacked connector assemblies to join adjacent ends of insulation tubing, including supplying a plurality of sheets of release liner material; supplying a plurality of layers of pressure sensitive transfer adhesive material; forming a laminar body comprising alternating sheets of release liner material and layers of pressure sensitive transfer adhesive material; and cutting from said laminar body a of a stack of release liner members and layers of pressure sensitive transfer adhesive material, each said release liner member being in contact with a layer of pressure sensitive transfer adhesive material and each said release liner member in said stack separated from adjacent release liner members in said stack by layers of pressure sensitive transfer adhesive material.

In some example embodiments, the layer of pressure sensitive transfer adhesive material includes a scrim to reinforce the layer of pressure sensitive transfer adhesive material.

In some example embodiments, the layer of pressure sensitive transfer adhesive material includes an acrylic-based pressure sensitive transfer adhesive material.

In some example embodiments, the layer of pressure sensitive transfer adhesive material includes a rubber-based pressure sensitive transfer adhesive material.

Example embodiments of the present general inventive concept can also be achieved by providing a method of applying a pressure sensitive transfer adhesive for connecting adjacent ends of insulation tubing, encompassing peeling a first release liner member away from a stack of release liner members, said first release liner member holding a layer of pressure sensitive transfer adhesive; attaching said first release liner member to an end face of a first section of insulation tubing; and pulling the release liner member away from the tube, whereby said layer of pressure sensitive transfer adhesive remains attached to the end face of the first section of insulation tubing.

Additional features and embodiments of the present general inventive concept will be set forth in part in the description which follows and, in part, will be obvious from the description, or may be learned by practice of the general inventive concept.

The present invention in some of its embodiments includes a pressure sensitive transfer adhesive and a disposable release liner member to hold the pressure sensitive transfer adhesive. The release liner member and pressure sensitive transfer adhesive are stacked on the non-adhesive-bearing side of another release liner member. The number of release liner members in a stack can be as many as two and higher. This stack allows for a peeling of one release liner member away from the stack of release liner members; the one release liner member is then attached to an end face of one section of insulation tubing (or tube). Once applied, the release liner is then pulled away from the tube, leaving an end face of tube with pressure sensitive transfer adhesive attached to it. The release liner is then disposed of.

In some embodiments of the present general inventive concept, a system to join adjacent ends of insulation tubing comprises a stack of a connector assemblies, each connector assembly including a release liner member and a layer of pressure sensitive transfer adhesive material, each said release liner member in said stack separated from adjacent release liner members in said stack by layers of pressure sensitive transfer adhesive material, each said release liner member being coated with a layer of pressure sensitive transfer adhesive material, such that when a release liner member is detached from said stack, said release liner member transports with itself a layer of pressure sensitive transfer adhesive material, said layer of pressure sensitive transfer adhesive material to bond to insulation tubing, whereby when said layer of pressure sensitive transfer adhesive material is positioned between a first section of insulation tubing and a second section of insulation tubing, one side of said layer of pressure sensitive transfer adhesive material bonds to the first section of insulation tubing and another side of said layer of pressure sensitive transfer adhesive material bonds to the second section of insulation tubing. In some embodiments, said layer of pressure sensitive transfer adhesive material includes a scrim to reinforce the layer of pressure sensitive transfer adhesive material. In some embodiments, said layer of pressure sensitive transfer adhesive material includes an acrylic-based pressure sensitive transfer adhesive material. In some embodiments, said layer of pressure sensitive transfer adhesive material includes a rubber-based pressure sensitive transfer adhesive material.

Some embodiments of the present general inventive concept comprise a method of fabricating stacked connector assemblies to join adjacent ends of insulation tubing, said method comprising: supplying a plurality of sheets of release liner material; supplying a plurality of layers of pressure sensitive transfer adhesive material; forming a laminar body comprising alternating sheets of release liner material and layers of pressure sensitive transfer adhesive material; and cutting from said laminar body of a stack of release liner members and layers of pressure sensitive transfer adhesive material, each said release liner member being coated with a layer of pressure sensitive transfer adhesive material and each said release liner member in said stack separated from adjacent release liner members in said stack by layers of pressure sensitive transfer adhesive material. In some embodiments, said layer of pressure sensitive transfer adhesive material includes a scrim to reinforce the layer of pressure sensitive transfer adhesive material. In some embodiments, said layer of pressure sensitive transfer adhesive material includes at least one pressure sensitive transfer adhesive material selected from the group consisting of an acrylic-based pressure sensitive transfer adhesive material and a rubber-based pressure sensitive transfer adhesive material.

Some embodiments of the present general inventive concept include a connector assembly to join adjacent ends of insulation tubing, comprising a release liner member coated with a layer of pressure sensitive transfer adhesive material, said release liner member transporting with itself a layer of pressure sensitive transfer adhesive material, said layer of pressure sensitive transfer adhesive material to bond to insulation tubing, whereby when said layer of pressure sensitive transfer adhesive material is positioned between a first section of insulation tubing and a second section of insulation tubing, one side of said layer of pressure sensitive transfer adhesive material bonds to the first section of insulation tubing and another side of said layer of pressure sensitive transfer adhesive material bonds to the second section of insulation tubing. In some embodiments, said layer of pressure sensitive transfer adhesive material includes a scrim to reinforce the layer of pressure sensitive transfer adhesive material. In some embodiments, said layer of pressure sensitive transfer adhesive material includes an acrylic-based pressure sensitive transfer adhesive material. In some embodiments, said layer of pressure sensitive transfer adhesive material includes a rubber-based pressure sensitive transfer adhesive material.

In some of the example embodiments, a stack of release liners, with inter-release liner layers of pressure sensitive transfer adhesive material, facilitates the speedy and efficient application of layers of pressure sensitive transfer adhesive material to join adjacent sections of insulation tubing. As each release liner is removed from the stack, said release liner transports with it a layer of pressure sensitive transfer adhesive material, which is applied between two adjacent sections of insulation tubing. The pressure sensitive transfer adhesive material adheres to the section of insulation tubing, and the remaining release liner is discarded. The next release liner in the stack is then ready to be removed from the stack, and the process of applying the layer of pressure sensitive transfer adhesive material between two adjacent sections of insulation tubing is repeated. The stack configuration facilitates the quick application of pressure sensitive transfer adhesive material.

In some embodiments, a method of applying a pressure sensitive transfer adhesive for connecting adjacent ends of insulation tubing includes peeling a first release liner member away from a stack of release liner members, said first release liner member carrying a layer of pressure sensitive transfer adhesive, attaching said first release liner member to an end face of a first section of insulation tubing, and pulling the release liner member away from the tube, whereby said layer of pressure sensitive transfer adhesive remains attached to the end face of the first section of insulation tubing.

In some embodiments, said layer of pressure sensitive transfer adhesive material includes a scrim to reinforce the layer of pressure sensitive transfer adhesive material. In some embodiments, said layer of pressure sensitive transfer adhesive material includes an acrylic-based pressure sensitive transfer adhesive material. In some embodiments, said layer of pressure sensitive transfer adhesive material includes a rubber-based pressure sensitive transfer adhesive material.

### BRIEF DESCRIPTION OF THE SEVERAL VIEWS OF THE DRAWINGS

The above-mentioned and additional features of the invention will become more clearly understood from the following detailed description of the invention read together with the drawings in which:

FIG. 1 is an exploded view of a laminar body including a plurality of sheets of release liner material coated with layers of pressure sensitive transfer adhesive material;

FIG. 2 is a perspective view of the laminar body shown in FIG. 1, showing stacks of release liner members and layers of pressure sensitive transfer adhesive material being cut from the laminar body;

FIG. 3 is a perspective view of a stack of release liner members and layers of pressure sensitive transfer adhesive material;

FIG. 4A is a view of one part of the process of applying a layers of pressure sensitive transfer adhesive material according to the present general inventive concept, showing the detachment of one release liner and an attached layer of pressure sensitive transfer adhesive material from the stack;

FIG. 4B is a view of another part of the process of applying a layer of pressure sensitive transfer adhesive material according to the present general inventive concept, showing the orientation of the release liner proximate a section of insulation tubing;

FIG. 4C is a view of one part of the process of applying a layer of pressure sensitive transfer adhesive material according to the present general inventive concept, showing the release liner being peeled away from the section of insulation tubing, leaving the layer of pressure sensitive transfer adhesive material on the section of insulation tubing;

FIG. 4D is a view of one part of the process of applying a layer of pressure sensitive transfer adhesive material according to the present general inventive concept, showing the joinder of two sections of insulation tubing with the layer of pressure sensitive transfer adhesive material between them;

FIG. 5A is a perspective view of a disposable release liner member and attached layer of pressure sensitive transfer adhesive material; and

FIG. 5B is a perspective view of a disposable release liner member and attached layer of pressure sensitive transfer adhesive material with scrim.

### DETAILED DESCRIPTION OF THE INVENTION

The present invention in some of its embodiments is directed toward a system and method to make stacked connector assemblies for readily joining adjacent ends of sections of insulation tubing. Each of the stacked connector assemblies includes a release liner member having a central opening. A layer of pressure sensitive transfer adhesive material is releasably attached to each side of the release liner member, such that one side of the layer of pressure sensitive transfer adhesive material is able to bond to an end face of one section of insulation tubing, and the other side of the layer of pressure sensitive transfer adhesive material is able to bond to an end face of the second section of insulation tubing.

In some of the several example embodiments, the present general inventive concept comprises a layer of viscous, pressure-sensitive adhesive (hereinafter generally “pressure sensitive transfer adhesive”) to position between adjacent ends of neighboring pieces of insulation tubing. In some embodiments, the layer of pressure sensitive transfer adhesive includes a scrim that acts as a reinforcing structure to keep the layer of pressure sensitive transfer adhesive material intact as a single body during and after application between two adjacent sections of insulation tubing.

Thus, in some of the several example embodiments, a connector assembly for joining adjacent ends of insulation tubing includes a layer of pressure sensitive transfer adhesive material, said layer of pressure sensitive transfer adhesive material capable of bonding to insulation tubing, whereby when said layer of pressure sensitive transfer adhesive material is positioned between a first section of insulation tubing and a second section of insulation tubing, said layer of pressure sensitive transfer adhesive material bonds to both the first section of insulation tubing and the second section of insulation tubing; and a disposable release liner member adapted to hold said layer of pressure sensitive transfer adhesive material prior to positioning said layer of pressure sensitive transfer adhesive material between the first section of insulation tubing and the second section of insulation tubing.

Reference will now be made to various example embodiments of the present general inventive concept, examples of which are illustrated in the accompanying drawings, wherein like reference numerals refer to like elements throughout. The following description of various embodiments is merely exemplary in nature and is in no way intended to limit the present general inventive concept, its application, or uses. The example embodiments are merely described below in order to explain the present general inventive concept by referring to the figures.

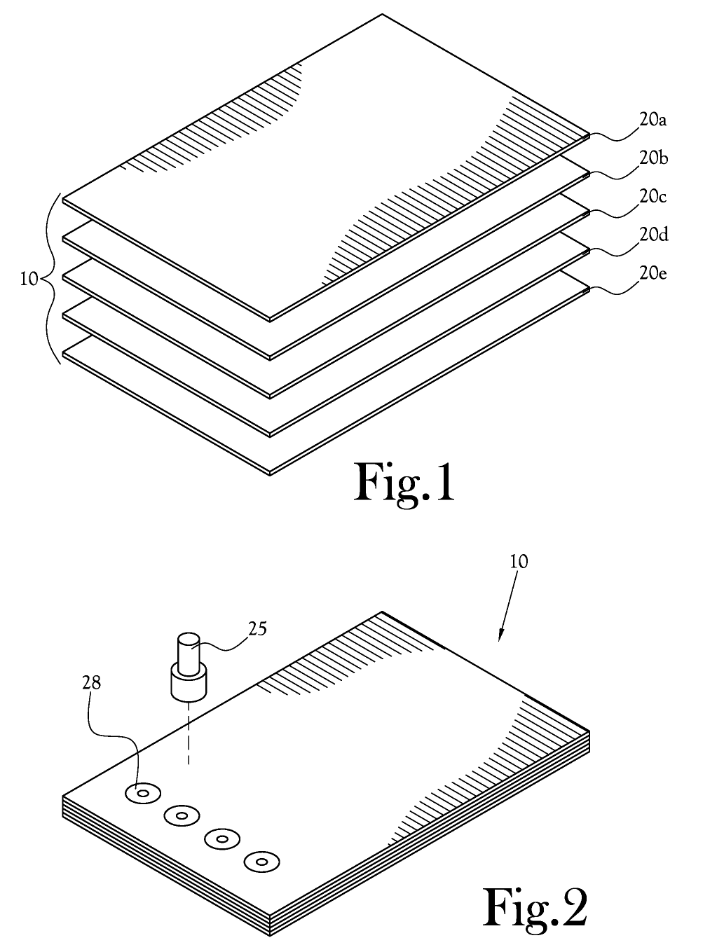

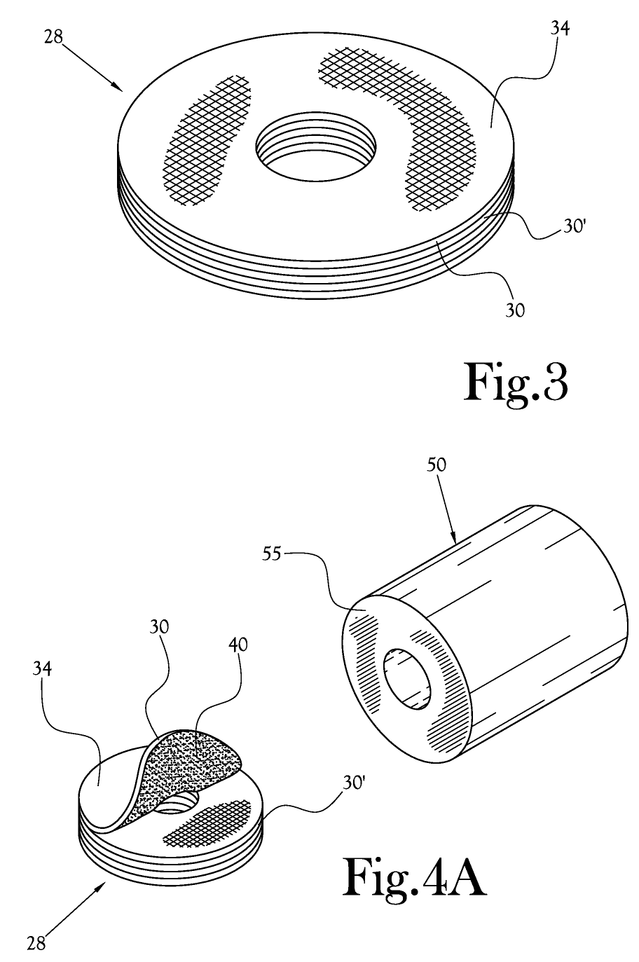

Turning to the Figures, FIG. 1 shows an exploded view of a laminate body involved in the manufacture of a stack of release liners according to one example embodiment of the present general inventive concept. As shown in FIG. 1, the laminate body 10 includes a plurality of sheet layers 20a-e of release liner material. Generally, a layer of pressure sensitive transfer adhesive material is interposed between each sheet layer 20a-e, resulting in a laminar body 10 shown in FIG. 2. As shown in FIG. 2, in a subsequent phase of the manufacturing process, a punch 25 is used to carve from the laminar body a stack 28 of substantially disc-like release liner members with pressure sensitive transfer adhesive material between each release liner member. FIG. 3 illustrates one example embodiment of a stack 28 of release liner members, each release liner member having a central opening; as a result of the manufacturing process, pressure sensitive transfer adhesive material is positioned between each release liner member (for example, between the top-most release liner member 30 and the next release liner member 30′ in the illustrated example embodiment). FIG. 3 further indicates an outboard or top-facing surface 34 of the top-most release liner member 30; generally, this outboard surface 34 is free of pressure sensitive transfer adhesive material.

Although the Figures indicated above illustrate one example embodiment of a fabrication process for producing a laminate body according to the present general inventive concept, other fabrication processes and methods are contemplated and are encompassed by the present general inventive concept. The illustrated example embodiment shown in FIGS. 1-2 is not intended to be limiting, and should not be read as such.

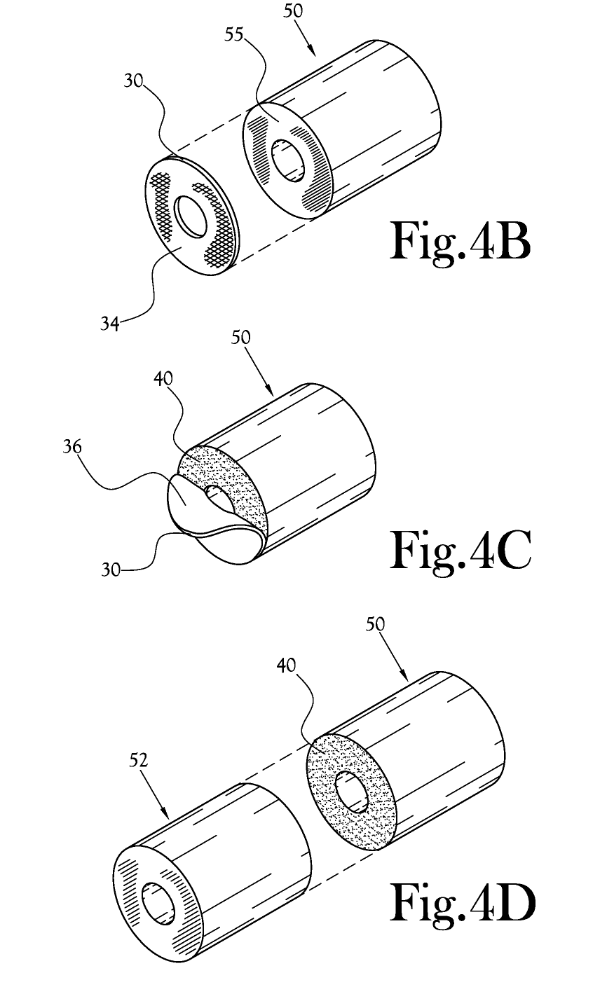

FIG. 4A through 4D illustrate one example embodiment of a method of using a release liner member with pressure sensitive transfer adhesive material to apply pressure sensitive transfer adhesive material to a section of insulation tubing. The illustrated example embodiment method also demonstrates some of the advantages of the present general inventive concept. As shown in FIG. 4A, the top-most or first release liner member 30 of the stack 28 is peeled away from the second release liner member 30′ immediately below the first release liner member 30. When the first release liner member 30 is peeled away from the stack 28, a layer of pressure sensitive transfer adhesive material 40 remains attached to the first release liner member 30; previous to the peeling away of the first release liner member 30 from the stack 28, the layer of pressure sensitive transfer adhesive material 40 resided between the first release liner member 30 and the second release liner member 30′. Once the first release liner member 30 has been fully detached from the stack 28, the first release liner member 30 is moved into position near a section of insulation tubing 50, as shown in FIG. 4B. The section of insulation tubing 50 includes an end face 55, where the layer of pressure sensitive transfer adhesive material 40 is to be applied. As shown in FIG. 4C, the first release liner 30 is abutted to the end face 55 of the section of insulation tubing 55, such that the layer of pressure sensitive transfer adhesive material 40 substantially covers and is in physical contact with the end face 55. The first release liner 30 is then moved away from the end face 55 of the section of insulation tubing 50, while the layer of pressure sensitive transfer adhesive material 40 remains deposited on the end face 55 of the section of insulation tubing 50. Next, as shown in FIG. 4D, a second section of insulation tubing 52 is moved into a position such that an end face of the second section of insulation tubing 52 is directly opposing and substantially adjacent to the end face 55 of the first section of insulation tubing 50, with the layer of pressure sensitive transfer adhesive material 40 between the two end faces. The layer of pressure sensitive transfer adhesive material 40 thereby adheres to the two proximate end faces of both sections of insulation tubing 50 and 52.

Thus, in the illustrated example embodiment, and in other example embodiments of the present general inventive concept, a stack of release liners, with inter-release liner layers of pressure sensitive transfer adhesive material, facilitates the speedy and efficient application of layers of pressure sensitive transfer adhesive material to join adjacent sections of insulation tubing. As each release liner is removed from the stack, said release liner transports with it a layer of pressure sensitive transfer adhesive material, which is applied between two adjacent sections of insulation tubing. The next release liner in the stack is then ready to be removed from the stack, and the process of applying the layer of pressure sensitive transfer adhesive material between two adjacent sections of insulation tubing is repeated. The stack configuration facilitates the quick application of pressure sensitive transfer adhesive material. In various embodiments, release liners may be peeled from the top of the stack or from the bottom of the stack.

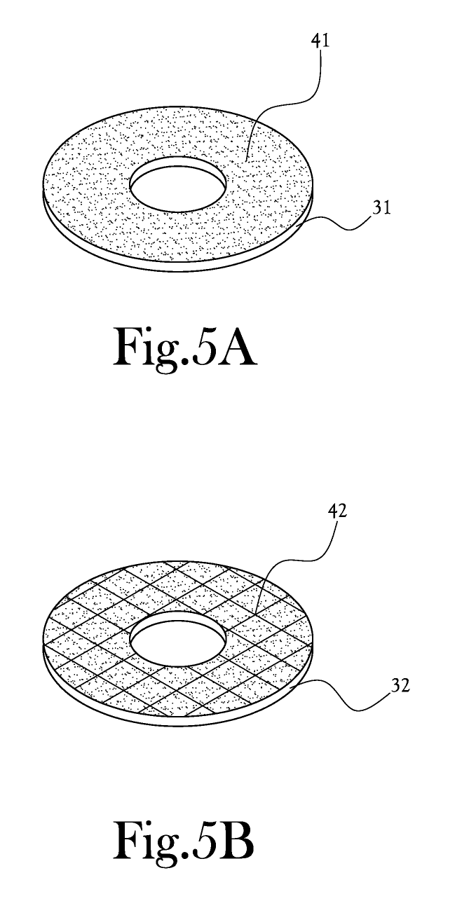

In some example embodiments of the present general inventive concept, such as that shown in FIG. 5A, the release liner 31 includes a layer of pressure sensitive transfer adhesive material 41 that includes no scrim or reinforcing structure within the layer of pressure sensitive transfer adhesive material 41 itself. In some example embodiments, such as that shown in FIG. 5B, the release liner 32 is connected to a layer of pressure sensitive transfer adhesive material 42 that does include a scrim or other reinforcing structure within the layer of pressure sensitive transfer adhesive material 42 itself. In these embodiments, the scrim or reinforcing structure generally comprises a fine, lightweight material worked in a criss-crossed pattern and in close contact with or surrounded by the pressure sensitive transfer adhesive material. Generally, the criss-crossed pattern of the scrim leaves substantial apertures allowing the free through-penetration of pressure sensitive transfer adhesive material, while still performing a reinforcing function and helping to keep the pressure sensitive transfer adhesive material together in a single body.

In some embodiments, the pressure sensitive transfer adhesive material is an acrylic-based pressure-sensitive pressure sensitive transfer adhesive. In some embodiments, the pressure sensitive transfer adhesive material is a rubber-based pressure-sensitive pressure sensitive transfer adhesive. Those of skill in the art will recognize that other pressure sensitive transfer adhesive materials will be suitable, and that the present general inventive concept is not limited to any particular pressure sensitive transfer adhesive material or any single class of pressure sensitive transfer adhesive materials.

Thus, some embodiments of the present general inventive concept include a connector assembly to join adjacent ends of insulation tubing, comprising a release liner member coated with a layer of pressure sensitive transfer adhesive material, said release liner member having a central opening. Said release liner member transports with itself a layer of pressure sensitive transfer adhesive material, said layer of pressure sensitive transfer adhesive material to bond to insulation tubing. When said layer of pressure sensitive transfer adhesive material is positioned between a first section of insulation tubing and a second section of insulation tubing, one side of said layer of pressure sensitive transfer adhesive material bonds to the first section of insulation tubing and another side of said layer of pressure sensitive transfer adhesive material bonds to the second section of insulation tubing. In several embodiments, the release liner member can include a split extending from the center opening to the outer edge. In some embodiments, said layer of pressure sensitive transfer adhesive material includes a scrim to reinforce the layer of pressure sensitive transfer adhesive material. In some embodiments, said layer of pressure sensitive transfer adhesive material includes an acrylic-based pressure sensitive transfer adhesive material. In some embodiments, said layer of pressure sensitive transfer adhesive material includes a rubber-based pressure sensitive transfer adhesive material. The present general inventive concept is not limited to any particular adhesive material or any single class of adhesive materials, and other pressure sensitive transfer adhesive materials may be suitable in some embodiments.

In various example embodiments, the present general inventive concept provides a method of bonding two insulation sleeves that is simpler compared to methods and assemblies known in the art. Compared to previous options, example embodiments of the present general inventive are thinner—that is, there is only the layer of pressure sensitive transfer adhesive remaining between the sleeves once fully applied. This thinness eliminates need for additional insulation by eliminating gaps between the insulation sleeves that are being bonded.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A connector assembly for joining adjacent ends of insulation tubing, comprising
a layer of pressure sensitive transfer adhesive material, said layer of pressure sensitive transfer adhesive material capable of bonding to insulation tubing, whereby when said layer of pressure sensitive transfer adhesive material is positioned between a first section of insulation tubing and a second section of insulation tubing, said layer of pressure sensitive transfer adhesive material bonds to both the first section of insulation tubing and the second section of insulation tubing; and
a disposable release liner member adapted to hold said layer of pressure sensitive transfer adhesive material prior to positioning said layer of pressure sensitive transfer adhesive material between the first section of insulation tubing and the second section of insulation tubing, said disposable release liner member to be separated from said layer of pressure sensitive transfer adhesive material after said layer of pressure sensitive transfer adhesive material bonds to the first section of insulation tubing and before said layer of pressure sensitive transfer adhesive material bonds the second section of insulation tubing.

2. The connector assembly of claim 1 wherein said layer of pressure sensitive transfer adhesive material includes a scrim to reinforce the layer of pressure sensitive transfer adhesive material.

3. The connector assembly of claim 1 wherein said layer of pressure sensitive transfer adhesive material includes an acrylic-based pressure sensitive transfer adhesive material.

4. The connector assembly of claim 1 wherein said layer of pressure sensitive transfer adhesive material includes a rubber-based pressure sensitive transfer adhesive material.

5. A method of fabricating stacked connector assemblies to join adjacent ends of insulation tubing, comprising:
supplying a plurality of sheets of release liner material;
supplying a plurality of layers of pressure sensitive transfer adhesive material;
forming a laminar body comprising alternating sheets of release liner material and layers of pressure sensitive transfer adhesive material; and
cutting from said laminar body a of a stack of release liner members and layers of pressure sensitive transfer adhesive material, each said release liner member being in contact with a layer of pressure sensitive transfer adhesive material and each said release liner member in said stack separated from adjacent release liner members in said stack by layers of pressure sensitive transfer adhesive material.

6. The method of claim 5 wherein said layer of pressure sensitive transfer adhesive material includes a scrim to reinforce the layer of pressure sensitive transfer adhesive material.

7. The method of claim 5 wherein said layer of pressure sensitive transfer adhesive material includes an acrylic-based pressure sensitive transfer adhesive material.

8. The method of claim 5 wherein said layer of pressure sensitive transfer adhesive material includes a rubber-based pressure sensitive transfer adhesive material.

9. A method of applying a pressure sensitive transfer adhesive for connecting adjacent ends of insulation tubing, comprising:
peeling a first release liner member away from a stack of release liner members, said first release liner member holding a layer of pressure sensitive transfer adhesive;
attaching said first release liner member to an end face of a first section of insulation tubing; and
pulling the release liner member away from the tube, whereby said layer of pressure sensitive transfer adhesive remains attached to the end face of the first section of insulation tubing.

10. The method of claim 9 wherein said layer of pressure sensitive transfer adhesive material includes a scrim to reinforce the layer of pressure sensitive transfer adhesive material.

11. The method of claim 9 wherein said layer of pressure sensitive transfer adhesive material includes an acrylic-based pressure sensitive transfer adhesive material.

12. The method of claim 9 wherein said layer of pressure sensitive transfer adhesive material includes a rubber-based pressure sensitive transfer adhesive material.
